(19) United States
(12) Patent Application Publication
(10) Pub. No.: US 2011/0052784 A1
(43) Pub. Date: Mar. 3, 2011

(54) PROCESS FOR MANUFACTURING FROZEN FRENCH FRIED POTATO SEGMENTS FOR OVEN RECONSTITUTION

(75) Inventor: Kenneth John Wilmot, Scarborough (GB)

(73) Assignee: McCain Foods Limited, Florenceville (CA)

(21) Appl. No.: 12/552,920

(22) Filed: Sep. 2, 2009

(51) Int. Cl. A23L 1/217

(52) U.S. Cl. 426/637; 426/438; 426/441

(57) ABSTRACT

A process for preparing par-fried and frozen potato products whereby the process consists of peeling, cutting the potato into segments, oil blanching the segments at a temperature of between 110° C. and 150° C., preferably between 130° C. and 140° C., for between 2 and 6 minutes, dipping the segments in water after the oil blanching stage followed by moderate temperature frying, preferably at 150° C. to 175° C., and freezing.

### FIELD OF THE INVENTION

This invention relates to the manufacture of French fries and in particular to French fries suitable for oven reconstitution.

### BACKGROUND OF THE INVENTION

The manufacture of French fries tend to follow a basic process of peeling, cutting, blanching in hot water or steam, drying, frying and freezing or chilling. This process as disclosed in U.S. Pat. No. 3,397,993 and U.S. Pat. No. 3,472,591 was originally invented to provide french fries for the food service (or catering) market. In the 1970's a new market was found in the retail trade for non-fried, ovenable french fries as is described in U.S. Pat. No. 3,865,964. In the 1980's another market was developed for microwaveable french fries as is disclosed in U.S. Pat. No. 4,109,020 or U.S. Pat. No. 4,219,575.

The processes for both ovenable french fries and microwaveable french fries used today are derivations of the existing food service process, in particular both employ a water/steam blanching stage, a drying stage and a high temperature frying stage.

U.S. Pat. No. 4,590,080 discloses a process for producing parfried and frozen potato product strips including but not limited to French fries, wherein the potato strips are adapted for reconstitution, immediately prior to consumption, in a microwave oven, conventional oven, convection oven, or finish fryer with highly desirable taste, colour and textural characteristics. The process comprises parfrying the potato strips under controlled time and temperature conditions to include two parfrying steps with an intermediate cooling step wherein the strips preferably are frozen to reduce the moisture content of the strips in accordance with a predetermined relationship of strip size, strip surface area, and moisture loss during processing. Potato strips prepared in accordance with the invention have been found to reconstitute with substantially optimum taste, color, and textural characteristics irrespective of the method of reconstitution.

U.S. Pat. No. 4,900,576 discloses a process for preparing parfried and frozen potato products and potato products produced thereby, which when reconstituted by finish frying or microwave oven heating have an organoleptic appeal of “fast food chain french fries” potato products. Pre-sliced potatoes are subjected to a first parfrying step, a first freezing step, a thawing step following the first freezing step, a second parfrying step and a second freezing step following the second parfrying step. The frozen potatoes may be reconstituted by microwave heating just prior to consumption.

Blanching in hot water was considered an essential part of the process for 3 reasons

1) To inactivate enzymes that may effect the colour and shelf-life.

2) To partially cook the potato and reduce the time required in the fryer.

3) Most critically, to leach surface sugars to help maintain the desired colour.

When potato products are fried, a chemical reaction takes place, known as Maillard's Reaction, on the surface of the product. Essentially reducing sugars are converted to brown pigments by the heat of the process. The higher the reducing sugars the darker the product. Conventionally high reducing sugar levels are lowered by leaching out the sugars by water blanching before frying to provide an acceptable final colour.

In recent years it has been found that the colour produced is associated with an undesirable known carcinogen namely acrylamide. The paler the colour the lower the acrylamide level.

The drying stage reduce the weight of the product by ˜15-20% by dehydration. This subsequently reduces the load on the frying stage and improves the texture of the product.

### SUMMARY OF THE INVENTION

According to a first aspect of the present invention there is provided a process for preparing fried and frozen potato products whereby the process consist of peeling, cutting the potato into segments, oil blanching the segments at a temperature of between 110° C. and 150° C., frying and freezing.

With the current invention the accepted stages of blanching in hot water and drying are replaced with one stage of blanching in low temperature oil.

The low temperature oil blanching stage is carried out at a lower temperature than conventional industrial frying which takes place at temperatures typically between 175° C. and 195° C. With the current invention it was discovered that if the segments of potato are oil blanched at a sufficiently low temperature then Maillard's Reaction does not take place to any significant degree while enzymes are still inactivated while some cooking of the potato takes place. At the same time water is evaporated from the potato thereby obviating the need for a the drying stage.

Furthermore, following the low temperature oil blanching stage it was found that it is not necessary to fry at conventional industrial frying temperatures, but a moderate frying temperature, typically between 150°-175° C., and preferably between 155° C. and 165° C., may be used while still providing the desired crispness, the advantage being a significant increase in the frying oil stability. It is known that a 10° C. decrease in frying temperature will double the usable life of the oil.

The potato may be cut into any desired shape.

Preferably the segments are oil blanched between 130° C.-140° C. for between 2 and 6 minutes.

Preferably the segments are dipped in water after the low temperature oil blanching stage and before the frying stage. The purpose of this is to partially re-hydrate the surface of the segments, remove any sugars brought to the surface during low temperature oil blanching, provide the facility to add colourants or other additives if necessary and, importantly, to modify the surface texture making the resultant surface texture crispier. The low temperature oil blanched product may be dipped in water for between 1 and 30 seconds.

Preferably the oil blanched potato is rested for 1 to 5 minutes and the rested product is then fried at a moderate temperature between 150° C. and 175° C., preferably between 155° C. and 165° C. for between 2 and 6 minutes and the frozen.

The process according to the present invention had several advantages, a reduction in energy usage, a reduction in water usage, a reduction in effluent treatment, a reduction in potato loss through leaching with a subsequent increase in potato recovery.

By eliminating a process step there is also a reduction in the space required for equipment and a reduction in capital investment.

The process also has a positive effect on the quality of the products when reconstituted either by oven baking, grilling (US broiling) or microwave heating and accordingly there is provided as a second aspect of the present invention a potato product processed according to the first aspect of the Invention. In particular while a conventional frozen french fry has a dry mealy internal texture, products made by the current invention have a softer, more moist centre which is more akin to a fresh fried product, a more natural and increased potato flavour with the absence of any noticeable oxidised off-flavours often describes as a “cardboard flavour and offers better control of the colour. The colour can be designed to range from a very pale creamy colour to a darker brown. The pale colour is very low in acrylamide.

The invention can be adapted to produce a wide variety of potato products In particular the invention will produce a product that can be microwave heated on a platewithout the use of susceptor material in the packaging and has a taste and texture similar to that of a traditional UK chip shop chip. All products may be oven reconstituted or grilled without having the characteristic “cardboard” flavour of typical ovenable potato products.

A further characteristic of the invention is that the products are fully fried when sold as opposed to conventional products which are only par-fried. This difference means that products produced by this invention need only be re-heated rather than be further cooked and reheated. Consequently the preparation time for the consumer is approximately halved.

According to a second aspect of the present invention there is provided a potato product which has been processed according to the first aspect of the present invention

### BRIEF DESCRIPTION OF THE DRAWINGS

The invention will be described by way of Example and with reference to the accompanying drawing which is a flow chart of the steps in a process according to the present invention.

FIG. 1 is a flow chart diagram showing the steps for manufacturing French fries suitable for oven reconstitution.

### DETAILED DESCRIPTION OF THE INVENTION

Unless otherwise stated, terminology used to describe the process should be understood to have the same meaning as understood by those skilled in the art.

Blanching refers to heating a food substrate in water, to inactivate enzymes, partially cook the substrate and leach out surface and sub-surface solutes without substantially modifying the molecular structure.

Low temperature Oil blanching refers to immersing a food substrate in oil or fat heated in a temperature range of 110° C. to 150° C. to inactivate enzymes, partially cook the substrate without substantially modifying the molecular structure.

Drying refers to passing air of a pre-determined velocity, at an elevated temperature and controlled humidity through a food substrate to remove water from the substrate.

Moderate frying refers to immersing a food substrate in oil or fat heated in a temperature range of 150° C. to 175° C.

Frying refers to immersing a food substrate in hot oil or fat heated in a temperature range of 175° C. to 195° C.

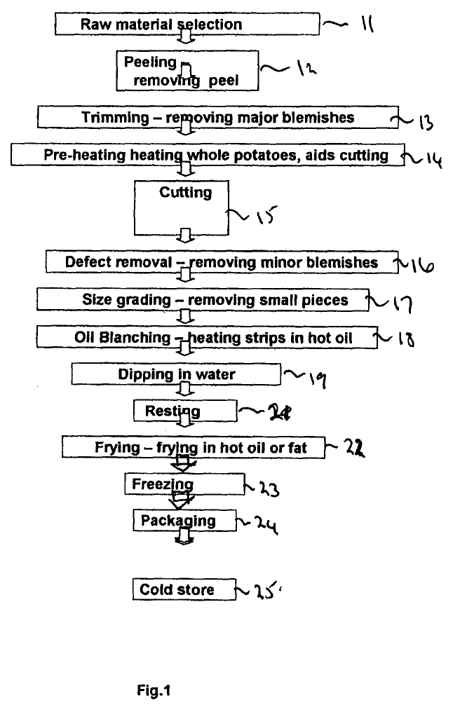

Potatoes of any variety commonly used by those familiar in the art of French fry manufacturing are selected, peeled, trimmed and pre-heated before cutting as shown in steps 11 to 15 of FIG. 1, although all these are not essential.

The potatoes are cut into segments of the desired shape and size by conventional means. Any defects are removed at step 16 of FIG. 1. The cut segments are then graded for size in step 17 of FIG. 1.

The segments are then transferred directly to an oil blancher in step 18 of FIG. 1. For the purpose of this invention low temperature oil blanching is defined as heating the product in hot oil or fat set between 110°-150° C., more typically between 120° C. and 150° C. and more usually between 130°-140 C. At these temperatures there is substantially no, or very little colour development. The blanch time will vary depending on the cut thickness and the type of potato product being manufactured. The blanch time will be between 1 and 6 minutes, typically between 3 and 4 minutes.

The low temperature oil blanching process is completed when the potato is partially cooked to a degree where the texture is considered to be softening. The time and temperature is variable according to the age and cut size of the potatoes. For example in the early part of the season the temperature may be raised and the time shortened while at the end of the season the temperature may be lowered and the time extended for a given cut size.

In step 19 of FIG. 1, the blanched segments are transferred to a water dip for between 1 and 30 seconds, preferably between 3 and 5 seconds at a temperature between 10° C. and 60° C. This stage has the effect of damaging the surface of the potato segments so that when passing through the next stage the damaged surface absorbs oil and becomes crisper. This significantly improves the texture when heating in a microwave oven. In addition any sugars brought to the surface during oil blanching are removed. This stage can also be used to add colourants or other additives if required.

The oil blanched potato pieces are allowed to stand and rest in step 21 of FIG. 1 for between 5 and 15 minutes to allow for cooling and a degree of retrogradation of the starch to take place.

The product is then transferred to a fryer in step 22 of FIG. 1. The temperature is usually set between 150°-175° C. and preferably between 155°-165° C. The fry time is typically set between 2 and 6 minutes, and usually between 2 and 4 minutes. The product is considered fried when the colour just starts to turn yellow.

Excess oil can be removed by conventional means known to those familiar in the art.

The product is then frozen before packaging.

The water dip and rest stages can be omitted but the resultant product would be inferior to that passing through all stages.

The invention will be further explained by way of Examples given below.

### Example 1

Potatoes of the variety Mans Piper were peeled and cut into 12×12 mm strips After rinsing off excess free starch the strips were weighed and immersed in oil in an oil blancher for 4 minutes at a temperature of approximately 140° C. They were then removed from the oil blancher, immersed in water at ambient temperature for 3 seconds then allowed to rest for 5 minutes. They were then immersed in a moderate frying medium for 3 minutes at a temperature of approximately 155° C. After reweighing the strips were frozen.

The oil blanching frying medium was a blend of beef tallow and rapeseed oil (1:2)

After 3 weeks the strips were cooked:

| Cooking Method | Time/Temp | Comments |
|---|---|---|
| Oven Bake. Preheat oven, spread | 8 mins/210° C. | Excellent colour, |
| product on a tray. Do not turn | | texture, flavour |
| over half way | | |
| Grill. Preheat grill. Spread product | 6 mins | Excellent flavour, |
| in grill pan. Place on middle | | texture. Slight |
| setting | | variation in colour |
| Microwave (800 w) Spread | 2 mins | Excellent colour, |
| 130-150 grm on a non-metallic | | flavour, internal |
| plate. Heat on full power. | | texture. Some |
| Remove and rest for 2 minutes. | | crispness |

### Example 2

Potatoes of the variety Mans Piper were peeled and cut into 19×19 mm strips. After rinsing off excess free starch the strips were weighed and immersed in oil in an oil blancher for 5 minutes at a temperature of approximately 133° C. They were then removed from the oil blancher, immersed in water at 45° C. for 3 seconds then allowed to rest for 5 minutes They were then immersed in a frying medium for 4 minutes at a temperature of approximately 155° C. After reweighing the strips were frozen. The oil blancher and the frying medium was a blend of beef tallow and rapeseed oil (1:2).

After 3 weeks the strips were cooked:

| Cooking Method | Time/Temp | | Comments |
|---|---|---|---|
| Oven Bake. Preheat oven, | 10 mins/220° C. | | Excellent colour, |
| spread product on a tray. | | | texture, flavour |
| Do not turn over half | | | |
| way. | | | |
| Grill. Preheat grill. Spread | 7 | mins | Excellent flavour, |
| product in grill pan. | | | texture. Slight |
| Place on middle setting. | | | variation in colour |
| Microwave (800 w) Spread | 2½ | mins | Excellent colour, |
| 130-150 grm on a | | | flavour, internal |
| non-metallic plate. Heat on | | | texture. Some |
| full power. Remove and rest | | | crispness |
| for 2 minutes. | | | |

1. A process for preparing par-fried and frozen potato products whereby the process consist of peeling, cutting the potato into segments, oil blanching the segments at a temperature of between 110° C. and 150° C., moderate temperature frying and freezing.

2. A process as claimed in claim 1 wherein the oil blanching stage is carried out at a temperature of between 120° C.-150° C. for between 2 and 6 minutes.

3. A process as claimed in claim 2, wherein the segments are oil blanched at between 130° C. and 140° C.

4. A process as claimed in claim 1, wherein the segments are dipped in water after the oil blanching stage and before the frying stage.

5. A process as claimed in claim 4, wherein the oil blanched segments are dipped in water for between 1 to 30 seconds at a temperature of between 10°-60° C.

6. A process as claimed in claim 5 wherein the oil blanched segments are dipped in water for 3-5 seconds at a temperature of between 20°-45° C.

7. A process as claimed in claim 4, wherein the oil blanched potato is rested for 1 to 5 minutes prior to moderate frying.

8. A process as claimed in claim 1, wherein the oil blanched segments are moderate fried at a temperature of between 150° C. and 175° C. for between 2 and 6 minutes and then frozen.

9. A process as claimed in claim 8, wherein the oil blanched segments are moderate fried at a temperature of between 155° C. and 165° C.

10. A potato product which has been processed according to claim 1.
